(19) United States
(12) Patent Application Publication
(10) Pub. No.: US 2008/0148739 A1
(43) Pub. Date: Jun. 26, 2008

(54) FLUIDIZED BED HEAVY FUEL COMBUSTOR

(76) Inventor: Marius A. Paul, Fullerton, CA (US)

Correspondence Address: BLACK LOWE & GRAHAM, PLLC, 701 FIFTH AVENUE, SUITE 4800, SEATTLE, WA, 98104, US

(21) Appl. No.: 11/748,728

(22) Filed: May 15, 2007

Related U.S. Application Data
(60) Provisional application No. 60/876,644, filed on Dec. 22, 2006.

(51) Int. Cl. F23C 10/00; F02C 3/04

(52) U.S. Cl. 60/805; 431/2

(57) ABSTRACT

A method and system for burning a first and second fuel includes injecting a first fuel into a super-heated highly compressed stream at approximately one-fourth of a stoichiometric ratio to the oxygen in the highly compressed stream. Combustion of the first fuel further heats the highly compressed stream. The highly compressed stream is admitted into a combustion vessel to fluidize a bed of a second fuel with the highly compressed stream. The second fuel is combusted to create a compressed effluent which fluidizes an adsorbent bed to remove sulfur from the compressed effluent.

### PRIORITY CLAIM

This application claims priority from provisional application Ser. No. 60/876,644 filed on Dec. 22, 2006 and is incorporated herein by reference.

### BACKGROUND OF THE INVENTION

Conventional existing power plants use heavy fuels such as: coals, crude petrol, and flared gases.

Heavy fuel oil (“HFO”) is a low-grade fuel primarily used in industrial boilers and other direct source heating applications (i.e., blast furnaces). It is also used as a principal fuel in marine applications in large diesel engines. Given its high boiling point and tar-like consistency, HFO typically requires heating before it can be moved through pipes or dispensed into a boiler or other heating vessel to be burned.

HFO is the least expensive of the refined oil fuels and can only be used by facilities that have preheating capabilities. HFO is typically high in sulfur and other impurities that are released into the air when the fuel is burned.

HFO combustion releases sulfur dioxide (SO₂), a key component of acid rain, into the atmosphere. The sulfur contained in HFO also forms sulfate particles (SO₄) that contribute to the formation of fine particulate matter, a pollutant with substantial implications for public health. Therefore, reducing sulfur emissions from HFO use reduces the release of pollutants into the air and benefits the environment and public health.

Because of its abundance and relatively low price, there is a need for burning HFO in a manner that does not release sulfur emissions in to the environment making HFO a viable means of generating motive force.

### SUMMARY OF THE INVENTION

A method and system for burning a first and second fuel includes injecting a first fuel into a super-heated highly compressed stream at approximately one-fourth of a stoichiometric ratio to the oxygen in the highly compressed stream. Combustion of the first fuel further heats the highly compressed stream. The highly compressed stream is admitted into a combustion vessel to fluidize a bed of a second fuel with the highly compressed stream. The second fuel is combusted to create a compressed effluent which fluidizes an adsorbent bed to remove sulfur from the compressed effluent.

To compress a stream of air generates an intermediately compressed stream of air in preparation for combustion of the HFO. Injecting a water mist into the intermediately compressed stream loads the intermediately compressed stream with water having a specific heat. Further compression of the intermediately compressed stream to generate a highly compressed stream. Heating the highly compressed stream generates the super-heated highly compressed stream for combustion of the HFO.

In accordance with other aspects of the invention, conducting the compressed effluent through a heat exchanger releases thermal energy to the highly compressed stream super-heating the highly compressed stream.

### BRIEF DESCRIPTION OF THE DRAWINGS

The preferred and alternative embodiments of the present invention are described in detail below with reference to the following drawings.

FIG. 1 shows a system for cleanly burning heavy fuels in one embodiment;

FIG. 2 shows a method for generating a super-heated highly compressed stream;

FIG. 3 shows a method for combusting a first fuel in one embodiment; and

FIG. 4 shows a method for combusting a second fuel in one embodiment.

### DETAILED DESCRIPTION OF THE PREFERRED EMBODIMENT

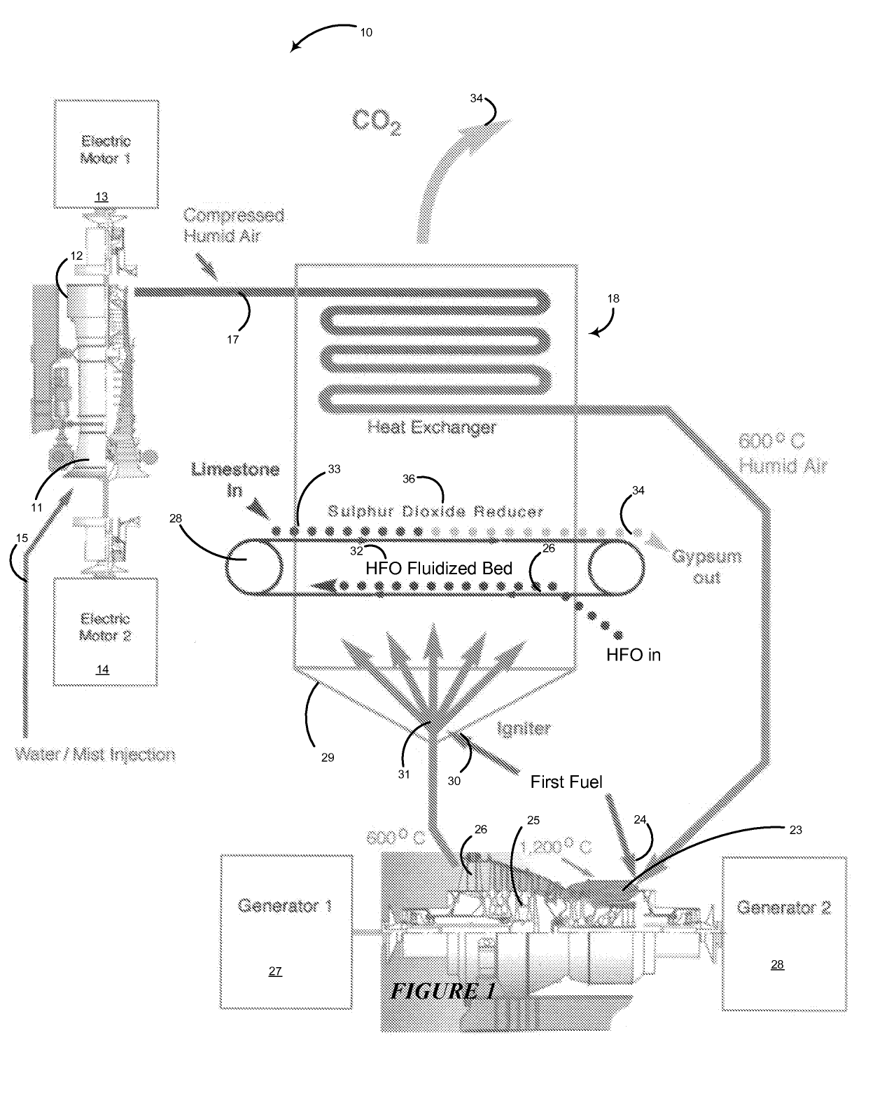

In illustrating a preferred embodiment of the present invention, FIG. 1 shows a system 10 for cleanly burning heavy fuel oil (“HFO”). The system 10 includes a compressor first stage 11 and a compressor second stage 12. The compressors 11, 12 are driven, in this non-limiting embodiment, by independent electronic motors 13 and 14. In alternative embodiments, may be driven by mechanical connection to rotating turbines described below. A water mist injector 15 is configured to inject water mist into during compression.

A highly compressed stream carrying the water mist emerges from the second compressor 12 to be conducted through a pipe 17, to a heat exchanger 18 contained within an HFO combustion vessel 29. In this non-limiting embodiment, a four-stage heat exchanger 18 is set forth. The stream is conducted through the heat exchanger 18 to impart thermal energy to the stream. In the preferred embodiment, thermal energy from the later combustion of the HFO is used to impart heat to the heat exchanger 18 in the manner described below. Thus, in this non-limiting embodiment, the heat exchanger 18 is contained within the HFO combustion vessel 29.

The compressed stream 22 is conducted to a combustion chamber 23 configured to contain the compressed stream at an elevated pressure inherent in combustion of a first fuel, optionally HFO. In the combustion chamber 23, the first fuel is injected into the stream at a first fuel injector 24 at approximately one-fourth of a stoichiometric ratio to oxygen contained in the stream. The first turbine 25, in this non-limiting embodiment, rotates based upon movement of the turbine induced by expanding the compressed stream. Blades (not shown) within the first turbine 25 are deflected to rotate the first turbine 25.

In this non-limiting embodiment, movement of the turbine is used to drive a first electric generator 27; other alternative uses including driving either of both of the first compressor 11 or the second compressor 12. In at least one embodiment, from the first tubine 25, the stream is then transported to a second turbine 26. The second turbine 26 optionally drives a second generator 28. While the embodiment illustrated herein includes two turbines 25, 26, any suitable configuration of turbines to extract mechanical energy from combustion of the first fuel can be advantageously used. Additionally, natural gas is one of a number of first fuels that may be suitably used for the first combustion. Configuration of the turbines will be dictated, in part, by selection of a first fuel.

The HFO combustion vessel 29 mentioned above as containing the heat exchanger 18 is the site of a second combustion. Because combustion in the combustion chamber 23 occurred in the presence of a super abundance of oxygen (four times the amount for full combustion of the first fuel) sufficient oxygen remains in the stream to support additional combustion within the HFO combustion vessel 29. An igniter 30 is provided to carry a flame in the compressed stream 31 as it enters the HFO combustion vessel 29, having fuel, in this case the first fuel, oxygen, and spark, the igniter acts as a pilot light for the HFO combustion vessel 29.

An HFO fluidized bed 32 for the HFO is shown, in this non-limiting case, coal is shown for convenience. As configured for coal, the compressed stream 31 enters the vessel 29 from below causing coal particles to suspend in the compressed stream 31 during the combustion process. The result is a turbulent mixing of gas and solids. The tumbling action, much like a bubbling fluid, provides more effective chemical reactions and heat transfer.

Fluidized bed combustion using the fluidized bed 32 reduces the amount of sulfur emitted in the form of SOx emissions. An adsorbent 33 is used to gather sulfur on a surface in a condensed layer within the vessel 29, thereby to precipitate 34 out sulfate during combustion. If limestone, a common adsorbent is used, the precipitate 34 occurs in the form of gypsum. The precipitation of the sulfate allows more efficient heat transfer from the vessel 29 to the heat exchanger 18 used to capture the heat energy. The heated precipitate 34 coming in direct contact with the heat exchanger 18 (heating by conduction) increases the efficiency.

Because of the efficient transfer of energy to the heat exchanger 18, combustion within the vessel can occur at cooler temperatures, thereby assuring that less NOx is also emitted. Fluidized-bed combustion burns fuel at temperatures of 1,400 to 1,700 F (750-900° C.), well below the threshold where nitrogen oxides form (at approximately 2,500° F./1400° C., the nitrogen and oxygen atoms in the combustion air combine to form nitrogen oxide pollutants).

As indicated above, the compressed stream 31 is directed upward to suspend the coal particles as well as the limestone particles to create a turbulent suspending effect. To facilitate the turbulent suspending effect, the HFO fluidized bed 32 and a limestone fluidized bed 36 are arranged on a conveyer chain transporter 28 having numerous voids to allow the suspending action of the fluidized beds 32, 36. The suspending action brings the flue gases into contact with the adsorbent 33, such as limestone or dolomite. More than 95% of the sulfur pollutants in coal can be captured inside the boiler by the adsorbent.

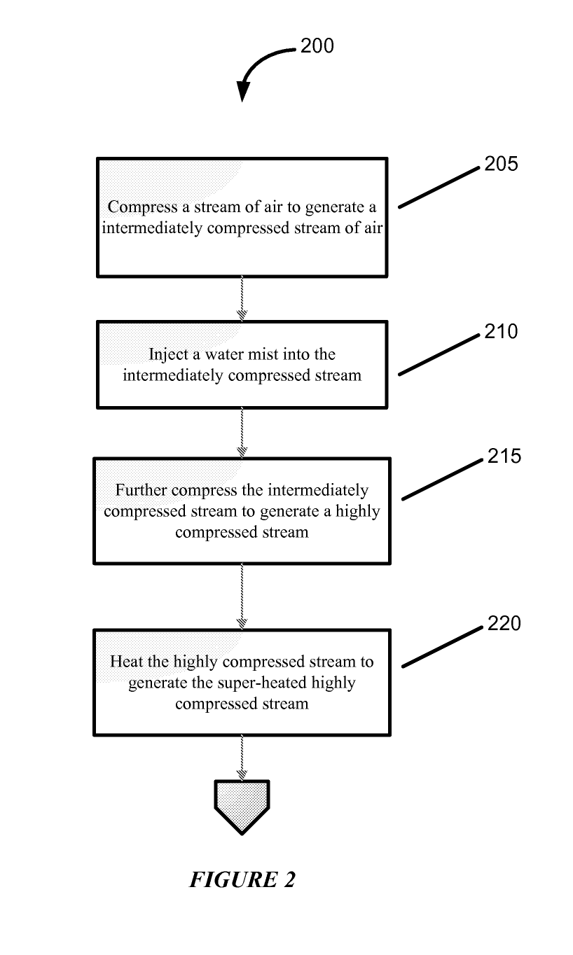

FIG. 2 shows a method 200 for preconditioning intake gasses for combustion of a first fuel such as HFO by generating a super-heated highly compressed stream. At block 205 a stream of air is compressed to generate an intermediately compressed stream of air for charging with the HFO. In one non-limiting embodiment, an isothermal double independent two stage constant pressure compressor compresses ambient air to form the stream of compressed air. The two stage compressor can maintain a constant pressure while supplying a variable mass flow. Selection of such a flow allows selection of output power and the mass flow correlates with the power produced at all regimes. Providing a constant pressure stream of air results in selectable thermal efficiency. Design parameters of the compressor, in this non-limiting embodiment the double independent two stage constant pressure compressor, may be optimized for the application.

At block 210 a water mist is injected into an intermediately compressed stream as it exits the first compressor, cooling the intermediately compressed stream. At block 215 the intermediately compressed stream is further compressed to generate a highly compressed stream. Optionally, a second water mist is injected to further cool the highly compressed stream. At block 220, the highly compressed stream is heated to in a heat exchanger to impart thermal energy to the highly compressed stream.

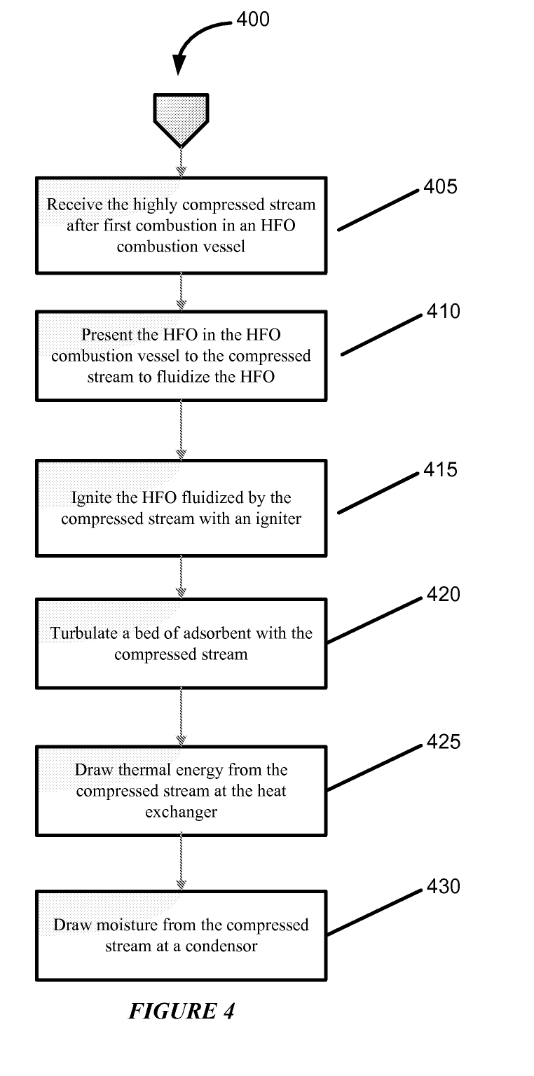

A heat exchanger is a device built for efficient heat transfer from one fluid to another, whether the fluids are separated by a solid wall so that they never mix, or the fluids are directly contacted. Heat exchangers may be classified according to their flow arrangement. In parallel-flow heat exchangers, the two fluids enter the exchanger at the same end, and travel in parallel to one another to the other side. In counter-flow heat exchangers the fluids enter the exchanger from opposite ends. The counter current design is most efficient, in that it can transfer the most heat. In one non-limiting embodiment, the stream is heated by passing it through a counter-current heat exchanger. Advantageously, the highly compressed stream is readily heated by heat in an effluent stream produced within a vessel at a block 425 (FIG. 4) below.

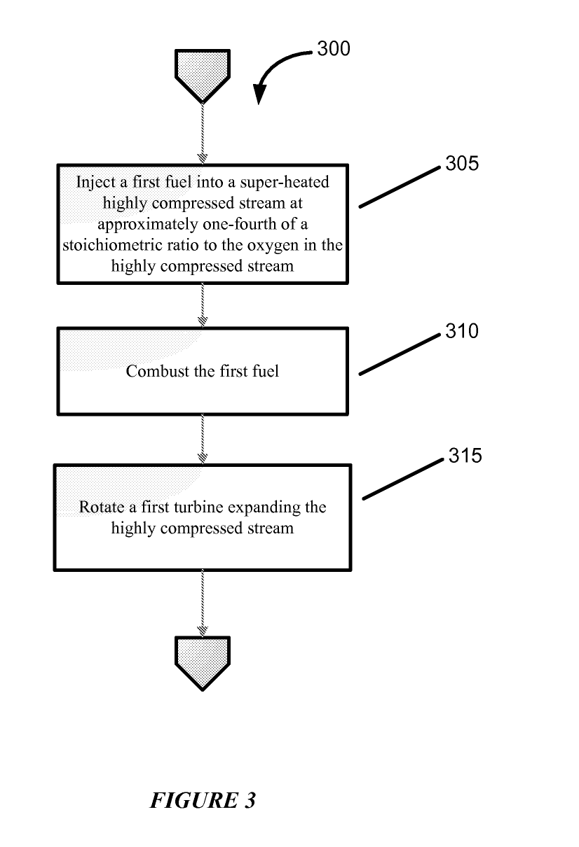

FIG. 3 shows a method 300 for combusting a first fuel, in one embodiment. At block 305 a first fuel is injected into the super heated highly compressed stream at approximately one-fourth of the stoichiometric ratio to oxygen contained in the highly compressed stream. Use of the remaining oxygen in the highly compressed stream will occur in a second combustion, described below.

At a block 310 the first fuel is combusted exploiting one-fourth of the oxygen in the highly compressed stream. Because of the plenitude of oxygen, and the high temperature and pressure of combustion, the first fuel is completely combusted in the superabundance of oxygen, removing any possible volatile byproducts. At block 315 the stream expanded by the heat of combustion expands in volume rotating a turbine. Water vapor in the highly compressed stream simultaneously expands further motivating the turbine. In a non-limiting embodiment, the rotating turbine drives a generator thereby producing electricity.

FIG. 4 discloses a method 400 for combusting a second fuel, the HFO in one non-limiting embodiment. At block 405 the highly compressed stream is introduced in an upward motion into a vessel to unite the highly compressed stream with the second fuel. The highly compressed stream has only exhausted one fourth of the oxygen therein owing to the first combustion at the block 310 (FIG. 3). When introduced to the vessel, the highly compressed stream with the second fuel presents a strong flow capable of suspending the second fuel within the vessel at a block 410, a process known as fluidizing the bed. The upward flow of the highly compressed stream counteracts the gravitational pull on the particles of the second fuel, thereby surrounding the particles as they are suspended, roiling in the flow.

At a block 415, the second fuel is ignited to combust within the vessel. Ignition is initiated by activation of an igniter in this embodiment; however ignition can be by any conventional means. Upon ignition and during the consequent combustion, the expansion of the gasses within the vessel drives the combustion byproducts through an adsorbent bed, fluidizing it at a block 420. Within the vessel, the absorption of sulfur occurs in conditions most likely to promote complete removal of those byproducts. Heat and pressure impart greater kinetic energy to molecules within the highly compressed effluent urging those molecules into reactive collision into lime molecules in the fluidized bed. As the lime reacts with the sulfur and nitrogen oxides removing effluent leaving only carbon dioxide, elemental nitrogen and steam. At a block 425, the compressed effluent is conducted through the heat exchanger releasing thermal energy from the compressed effluent. As the compressed effluent gives up its thermal energy to the heat exchanger, the heat exchanger, in turn, heats the highly compressed stream and superheats the stream, as described above at the block 220 (FIG. 2).

In the course of compression, at the block 210 (FIG. 2), the water mist injected into the compressed stream gave a higher specific heat to the compressed stream. The water remains available for condensation from the compressed stream. At a block 430, the water is condensed from the compressed stream at a condenser.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for burning fuels comprising:
injecting a first fuel into a super-heated highly compressed stream at approximately one-fourth of a stoichiometric ratio to the oxygen in the highly compressed stream;
combusting the first fuel to further heat highly compressed stream;
fluidizing a bed of a second fuel with the highly compressed stream;
combusting the second fuel to create a compressed effluent; and
fluidizing an adsorbent bed with the compressed effluent to remove sulfur.

2. The method of claim 2, wherein:
adsorbent includes a lime compound.

3. The method of claim 1, wherein combusting the first fuel further includes:
allowing the highly compressed stream to expand thereby turning a first turbine.

4. The method of claim 1, wherein combusting the second fuel further includes:
igniting the second fuel with an igniter.

5. The method of claim 1, further comprising:
compressing a stream of air to generate an intermediately compressed stream of air;
injecting a water mist into the intermediately compressed stream; and
further compressing the intermediately compressed stream to generate a highly compressed stream.

6. The method of claim 5, further comprising:
conducting the compressed effluent through a heat exchanger releasing thermal energy from the compressed effluent to generate the super-heated highly compressed stream.

7. The method of claim 1, further comprising:
discharging the compressed effluent through a condenser resulting in pure water and cool gases.

8. The method of claim 1, wherein the second fuel is a heavy fuel.

9. A system for cleanly burning fuels, the system comprising:
a first injector configured to inject a first fuel into a super heated highly compressed stream at approximately one-fourth of a stoichiometric ratio to the oxygen in the highly compressed stream;
a first combustion chamber configured to combust the first fuel heating the compressed stream; and
combustion vessel including:
a fluidized fuel bed for fluidizing a second fuel using the compressed stream;
a igniter for igniting the compressed stream at the fluidized fuel bed to produce a compressed effluent; and
a fluidized adsorbent bed for adsorbing sulfur from the compressed effluent.

10. The system of claim 9, wherein the first combustion chamber further includes a first turbine to expand the highly compressed stream.

11. The system of claim 9, wherein the adsorbent includes:
a lime compound.

12. The system of claim 9, further comprising:
a compressor configured to compress a stream of air into a highly compressed stream; and
at least one water mist injector to inject water into the stream of air.

13. The system of claim 12, wherein the combustion vessel further comprises:
a heat exchanger configured to superheat the highly compressed stream exploiting heat in the compressed effluent.

14. The system of claim 9 further comprising:
a condenser configured to condense generally pure water from the compressed effluent.

15. A combustion vessel for burning a fuel, the vessel comprising:
a outer shell defining an interior and configured to contain a combustion reaction of the fuel within the interior;
an intake port configured to admit a highly compressed stream of air into the interior;
a fuel bed to fluidize under an influence of the highly compressed stream;
an igniter to initiate combustion of the fuel bed converting the highly compressed stream into a compressed effluent stream;
an adsorbent bed to fluidize under the influence of the compressed effluent stream;
a heat exchanger to remove heat from the compressed effluent stream; and
an exhaust port configured to exhaust the compressed effluent stream.

16. The vessel of claim 15, wherein the adsorbent bed includes:
a lime based compounds.

17. The vessel of claim 15, wherein the heat exchanger is configured to superheat a moist compressed stream of air.

18. The vessel of claim 15, wherein the fuel is a heavy fuel.

19. The vessel of claim 15, wherein the exhaust port includes a condenser to remove water from the compressed effluent stream.

20. The vessel of claim 19, wherein the condenser includes:
a water injector to inject the removed water into a compressed stream of air.
